(19) United States
(12) Patent Application Publication
(10) Pub. No.: US 2002/0037714 A1
(43) Pub. Date: Mar. 28, 2002

(54) Method and system of remotely controlling a portable terminal and a computer product

(76) Inventors: Naohito Takae, Kawasaki (JP); Hiroyuki Tani, Obihiro (JP); Kazuhiro Fujikawa, Aomori (JP)

Correspondence Address: STAAS & HALSEY, Suite 500, 700 Eleventh Street, N.W., Washington, DC, 20001, US

(21) Appl. No.: 09/760,879

(22) Filed: Jan. 17, 2001

(30) Foreign Application Priority Data
Sep. 27, 2000 (JP) 2000-295074

(51) Int. Cl. H04M 3/00

(52) U.S. Cl. 455/419; 455/420

(57) ABSTRACT

A remote control center sends a setting changing mail, to a portable telephone, that collectively changes the contents of a built-in memory and an attachable/detachable storage medium of the portable telephone 20. The portable telephone collectively updates the contents in the built-in memory and the storage medium based on the content of the setting changing mail.

### FIELD OF THE INVENTION

The present invention relates to a technology of remotely controlling a portable terminal with an external device. The portable terminal is the one composed of a) a device main body provided with a built-in memory, and b) an attachable/detachable storage medium.

### BACKGROUND OF THE INVENTION

Recently, portable telephones have been widely used. Some of these portable telephones are provided with a storage medium (there are many types of storage media available in the market) in its telephone main body. Accordingly, such a portable telephone can function not only as a communication terminal, but also as an e-commerce (electronic commerce) terminal. More specifically, the recent portable telephone includes an ME (Module Element) that realizes a function as a telephone main body, an SIM card (Subscriber Identity Module Card) that realizes a function as a subscriber identifying module, and an IC card (Integrated Circuit Card) that functions in various manners as an external storage medium (for example, this may be a credit card).

In this manner, with the spread of functions realized by the portable telephone, there has been an increasing need to change these functions to meet the users' (subscribers') request. In other words, when the subscriber wishes to change the setting in the portable telephone, a communication provider has to change the functions of the ME, SIM card, and IC card using the technology remote control.

There has been known a method of remotely controlling a plurality of network-linked computer systems using e-mail (electronic mail). FIG. 7 shows a conventional remote control method in which a plurality of computer systems are controlled remotely. A managing device 70 remotely controls a plurality of computer systems 71, 72, and 73 by sending a setting changing e-mail to each, so that, upon receipt of the setting changing e-mail, each of the computer systems 71, 72, and 73 changes the settings therein to the one instructed in the setting changing e-mail.

The foregoing method of remotely controlling a plurality of computer systems can be adapted to remotely control a portable telephone composed of the ME, SIM card, and IC card. FIG. 8 shows a case in which a plurality of portable telephones are remotely controlled. A managing device 80 changes the function of each of an ME 91, an SIM card 92, and an IC card 93 individually by sending an ME setting changing mail, an SIM card setting changing mail, and an IC card setting changing mail separately to a portable telephone 90. The portable telephone 90 has the ME 91, SIM card 92, and IC card 93.

Conventionally, when the subscriber wishes to change the set-ups for the functions of the ME, SIM card, and IC card collectively, the subscriber is required to send a separate mail corresponding to the ME, SIM card, and IC card. However, there is a disadvantage in this that the efficiency of the work reduces. In particular, because it is difficult to take synchronization, a communication is disabled if the portable telephone receives the setting changing mail for the SIM card before the one for the ME.

Furthermore, conventionally, when the subscriber wishes to change the set-ups in a newly inserted SIM card or IC card, or to change the set-ups in a new ME into which the SIM card or IC card is reinserted in the same manner as before, the subscriber has to do so by sending a mail again. This poses a problem that efficiency in the set-up change in the portable telephone is not satisfactory.

### SUMMARY OF THE INVENTION

It is an object of the present invention to provide a technology in which it is possible to efficiently change the setting in portable terminals.

According to one aspect of the present invention a user sends a request to an external device to effect a change in the setting of his/her portable terminal. Upon receipt of such a request, the external device sends a mail to the portable terminal. This mail contains a computer program which changes a part or all of the content of the memory of the portable terminal thereby changing the setting in the portable terminal. Therefore, the setting of the portable terminal can be changed efficiently.

According to another aspect of the present invention an external device sends a mail to a portable terminal. This mail contains a computer program which changes a part or all of the content of the memory of the portable terminal thereby changing the setting in the portable terminal. Upon receipt of this, the portable terminal executes the computer program, thereby, the setting in the portable terminal is changed. Therefore, the setting of the portable terminal can be changed efficiently.

Other objects and features of this invention will become apparent from the following description with reference to the accompanying drawings.

### BRIEF DESCRIPTION OF THE DRAWINGS

FIG. 1 is a view depicting an arrangement of a portable telephone remote control system in accordance with the first embodiment of the present invention.

FIG. 2 is a block diagram depicting an arrangement of a remote control center 10 shown in FIG. 1.

FIG. 3 is a block diagram depicting an arrangement of a portable telephone 20 shown in FIG. 1.

FIG. 4 is a flowchart detailing an operation in the first embodiment of the present invention.

FIG. 5 is a flowchart detailing an operation in the second embodiment of the present invention.

FIG. 6 is a flowchart detailing an operation in the third embodiment of the present invention.

FIG. 7 is a view explaining a prior art remote control on computer systems.

FIG. 8 is a view explaining a prior art remote control on a portable telephone.

### DESCRIPTION OF THE PREFERRED EMBODIMENTS

Three preferred embodiments of a portable terminal remote control method of the present invention are described below with reference to the accompanying drawings. These embodiments will be explained by way of a portable telephone remote control system adapting the portable terminal remote control method of the present invention.

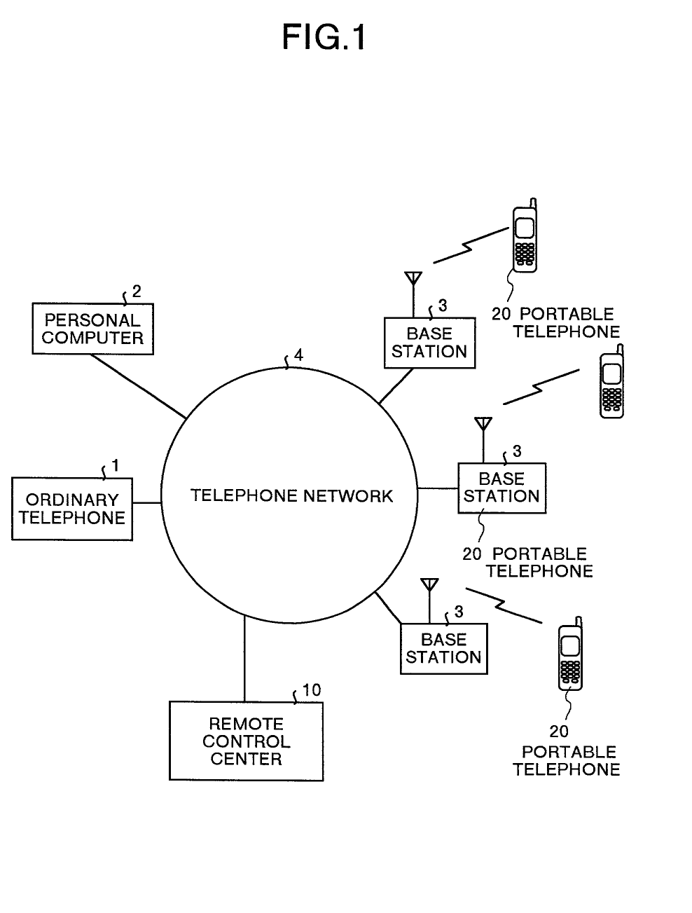

An arrangement of a portable telephone remote control system in accordance with the first embodiment of the present invention will now be explained. FIG. 1 is a view depicting an arrangement of the portable telephone remote control system in accordance with first embodiment of the present invention. The portable telephone remote control system of first embodiment is formed by liking to a telephone network 4 a general telephone machine 1, a personal computer 2, a remote control center 10 that is owned by a communication provider as a server, and a portable telephone 20 through a local station.

Schematically, the remote control center 10 accepts a request related to a set-up change in the portable telephone 20 from the subscriber of the portable telephone 20 through the general telephone machine 1, personal computer 2, or the portable telephone 20. Then, the remote control center 10 changes the setting in the portable telephone 20 by means of remote control by sending a setting changing application suitable to the request to the portable telephone 20 owned by said subscriber.

It should be noticed that the portable telephone remote control system of first embodiment is characterized by a manner according to which the setting in the portable telephone 20 are changed, and more specifically, a job of sending a setting changing application to the portable telephone 20 in the form of a telegraphic message so as to collectively change the setting in the telephone main body and storage medium forming the portable telephone 20.

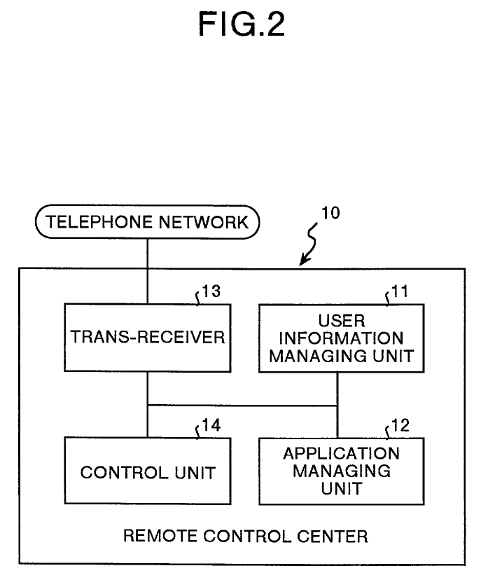

Next, the following description will describe an arrangement of the remote control center 10 shown in FIG. 1. FIG. 2 is a block diagram depicting an arrangement of the remote control center 10 shown in FIG. 1. As shown in the drawing, the remote control center 10 shown in FIG. 1 comprises a user information managing unit 11, an application managing unit 12, a trans-receiver 13, and a control unit 14.

Schematically, the remote control center 10 not only controls a communication among the general telephone machine 1, personal computer 2, and portable telephone 20, all linked to the telephone network 4, but also runs a job of changing the setting in the portable telephone 20 by sending a setting changing application to the portable telephone 20. An arrangement as to the communication control job is the same as that in a general network managing station. Thus, the explanation of the foregoing is omitted herein, and the following description will describe only the setting changing job.

The user information managing unit 11 manages subscriber identity information of the subscriber of the portable telephone 20. More specifically, the user information managing unit 11 stores and manages useful information in authenticating the subscriber's identification, such as the telephone number of the portable telephone 20, the name of the subscriber, and his password, and useful information in determining the setting subject to changing, such as the current setting in the portable telephone 20.

The application managing unit 12 manages a setting changing application for changing the setting in the portable telephone 20. The setting changing application referred to herein is an application capable of collectively changing stored contents in the telephone main body and storage medium forming the portable telephone 20, namely, a Module Element (hereafter, ME), an SIM card (Subscriber Identity Module Card), and an IC card (Integrated Circuit Card).

For example, contents in the setting changing application include the change from a ring sound OFF mode to a ring sound ON mode, addition/change of a function realized by the telephone main body, SIM card, and IC card, a set-up change (in case of loss and theft) for disabling all the functions realized by the telephone main body, SIM card, and IC card, etc. These examples will be described more in detail below.

The trans-receiver 13 carries out a communication related to the setting changing job among the general telephone machine 1, personal computer 2, and portable telephone 20 via the telephone network 4. More specifically, the trans-receiver 13 receives information containing a request related to a set-up change in the portable telephone 20 from the subscriber of the portable telephone 20 through the general telephone machine 1, personal computer 2, or portable telephone 20. When accepting the request, the trans-receiver 13 also receives useful information in authenticating the subscriber's identification, such as the telephone number of the portable telephone 20, the name of the subscriber, and his password. Also, the trans-receiver 13 sends a setting changing application suitable to the request to the portable telephone 20.

The control unit 14 carries out a job related to the setting changing job by controlling each component in the remote control center 10. More specifically, the control unit 14 authenticates the subscriber's identification as an authorized subscriber by comparing the telephone number of the portable telephone 20, the name of the subscriber, and his password received from the trans-receiver 13 with the user identity information managed by the user information managing unit 11. Upon authentication as the authorized subscriber, the control unit 14 determines a suitable setting changing application to the request related to the set-up change in the portable telephone 20 received from the trans-receiver 13 out of applications managed in the application managing unit 12.

Then, the control unit 14 generates a telegraphic message (mail) containing the setting changing application thus determined, and sends the mail to the portable telephone 20 from the transmission/reception of device 13. When sending the mail containing the setting changing application, the control unit 14 appends a set-up change identifier so as to be distinguished from other normal mails. If the portable telephone 20 cannot receive the setting changing application because its power is turned OFF or it is present in a communication disabled area, the control unit 14 keeps sending the setting changing application until the portable telephone 20 receives the same.

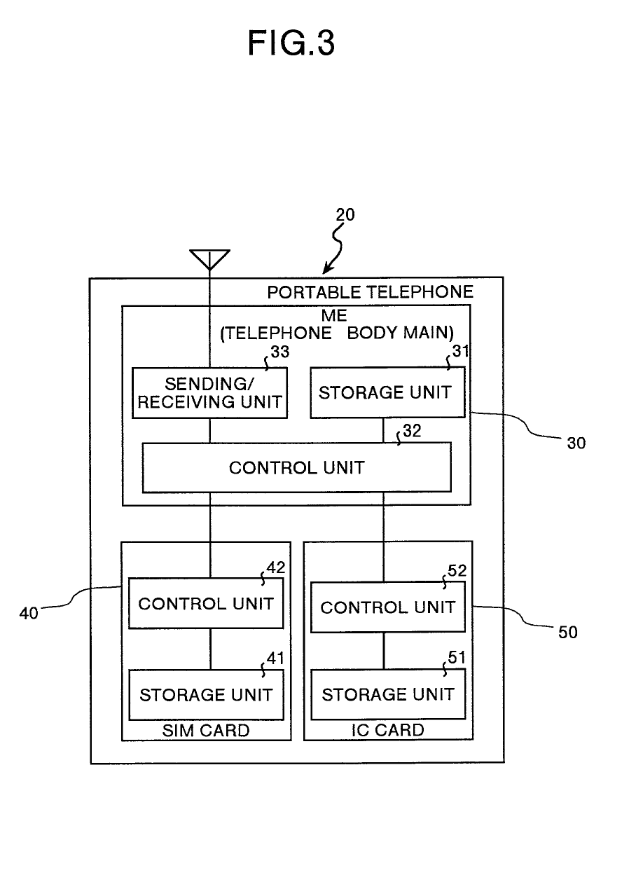

Next, the following description will describe an arrangement of the portable telephone 20 shown in FIG. 1 with reference to FIG. 3. FIG. 3 is a block diagram depicting the arrangement of the portable telephone 20 shown in FIG. 1. As shown in the drawing, the portable telephone 20 shown in FIG. 1 comprises an ME 30 serving as the telephone main body, an SIM card 40 serving as a storage medium and an IC card 50, both attachable/detachable to/from the portable telephone 20.

Schematically, the portable telephone 20 not only functions as a communication terminal or an e-commerce terminal by using the ME 30, SIM card 40, and IC card 50, but also runs a job of changing the setting in the ME 30, SIM card 40, and IC card 50 by receiving the setting changing application from the remote control center 10.

An arrangement of each of the ME 30, SIM card 40, and IC card 50 that allow functions as the communication terminal and e-commerce terminal is the same as that of a general portable telephone provided with an IC card. Thus, a detailed explanation of the foregoing is omitted herein, and the following description will briefly describe the function of each of the ME 30, SIM card 40, and IC card 50, and then the content related to the setting changing job.

As shown in FIG. 3, the ME 30 comprises a storage unit 31, a control unit 32, and a trans-receiver 33. Also, the SIM card 40 comprises a storage unit 41 and a control unit 42, and the IC card 50 comprises a storage unit 51 and a control unit 52. Although it is not shown in FIG. 3, it should be appreciated that the ME 30 also includes essential components to realize the function as a general portable telephone, such as a key input unit (manipulation unit), a voice input unit, voice output unit, and a display unit.

The ME 30 realizes the functions as the telephone main body. More specifically, it realizes functions of: transmission/reception of sound, transmission/reception of mails, downloading various kinds of applications (Java applets), downloading music data or image data via the Internet, allowing a processor-to-processor communication with the SIM card 40 and IC card 50 inserted into the portable telephone 20, allowing a communication with another portable telephone, a POS terminal, a vending machine by means of a wireless technique, such as Bluetooth, allowing a communication with a noncontact IC card using a noncontact IC card reader/writer, etc.

In the ME 30, the storage unit 31 stores programs and data of various kinds used in realizing the foregoing functions, and the control unit 32 runs a job to effect the foregoing functions by controlling the storage unit 31.

The SIM card 40 is a storage medium issued by a communication provider, and also realizes a function as a subscriber identity module that authenticates the subscriber's identification of the portable telephone 20. More specifically, in the SIM card 40, the storage unit 41 stores the subscriber identity information (electronic certificate) and terminal information required for a communication with an external device and a cryptography program for encrypting the foregoing information, and the control unit 42 runs a job to effect the function as the subscriber identity module by controlling the storage unit 41.

The IC card 50 is a storage medium issued by a third party other than the communication provider, and realizes various kinds of functions as an external storage medium to the portable telephone 20. More specifically, the IC card 50 realizes the functions, such as a credit card, a cash card, tickets of various kinds, a commuting path, a shop's trading stamp card, a patient's registration card, an image storage medium, and a music storage medium.

In the IC card 50, the storage unit 51 stores programs and data of various kinds used in realizing the foregoing functions, and the control unit 52 runs a job to effect the foregoing functions by controlling the storage unit 51.

The above description explained a case where the SIM card 40 and IC card 50 include their respective control units 42 and 52. It should be appreciated, however, that the present invention is not limited to the above case, and can be adapted to a case where neither the SIM card 40 nor IC card 50 is provided with their respective control units 42 and 52. In this case, the control unit 32 in the ME 30 makes the SIM card 40 and IC card 50 effect their functions by using the data and programs stored in their respective storage units 41 and 42.

The above description explained a case where the ME 30 SIM card 40, and IC card 50 effect their respective functions separately. It should be appreciated, however, that the present invention is not limited to the above case, and can be adapted to a case where the ME 30, SIM card 40, and IC card 50 effect one function as a whole. In this case, the ME 30, SIM card 40, and IC card 50 effect one function as a whole by using appropriate data and programs stored in their respective storage units 31, 32, and 33.

Also, the above description explained a case where the storage units 31, 32, and 33 provided respectively in the ME 30, SIM card 40, and IC card 50 store different data and programs. It should be appreciated, however, that the present invention is not limited to the above case, and can be adapted to a case where the storage units 31, 32, and 33 store the same data and programs. In this case, the ME 30, SIM card 40, and IC card 50 effect the same function.

As explained above, the portable telephone 20 realizes various kinds of functions by using the ME 30, SIM card 40, and IC card 50. Also, the portable telephone 20 runs a job of changing the setting related to these functions. The following description will describe the contents related to the setting changing job.

The trans-receiver 33 in the ME 30 receives a setting changing application that collectively changes the setting related to the functions realized by the ME 30, SIM card 40, and IC card 50 from the remote control center 10 via the telephone network 4. More specifically, the trans-receiver 33 receives a mail that contains the setting changing application and is appended with the set-up change identifier.

The control section 32 in the ME 30 opens the received mail in response to the set-up change identifier appended to the same, and activates the setting changing application contained therein, whereby the setting related to the functions realized by the ME 30, SIM card 40, and IC card 50 are changed collectively. More specifically, the control section 32 accesses not only the ME 30, but also the SIM card 40 and IC card 50 (processor-to-processor communication), and changes the setting collectively by adding/deleting/changing the programs and data of various kinds in the ME 30, SIM card 40, and IC card 50.

Concrete examples of the set-up change include: a set-up change that collectively upgrades the version of certain functions realized by the ME 30, SIM card 40, and IC card 50, and a set-up change (set-up change in case of loss and theft) that collectively disables all the functions realized by the ME 30, SIM card 40, and IC card 50, etc.

In case that the ME 30, SIM card 40, and IC card 50 effect one function as a whole by using appropriate data and programs stored in their respective storage units 31, 32, and 33, a set-up change that changes the foregoing data and programs collectively is available. Also, in case that the storage units 31, 32, and 33 store the same data and programs, a set-up change that changes the foregoing data and programs collectively is available.

The above description explained a case where the setting in the ME 30, SIM card 40, and IC card 50 are changed by activating the setting changing application by means of the control unit 32 in the ME 30. It should be appreciated, however, that the present invention is not limited to the above case, and can be adapted to a case where the setting in the ME 30, SIM card 40, and IC card 50 are changed principally by the control unit 42 in the SIM card 40 or the control unit 52 in the IC card 50.

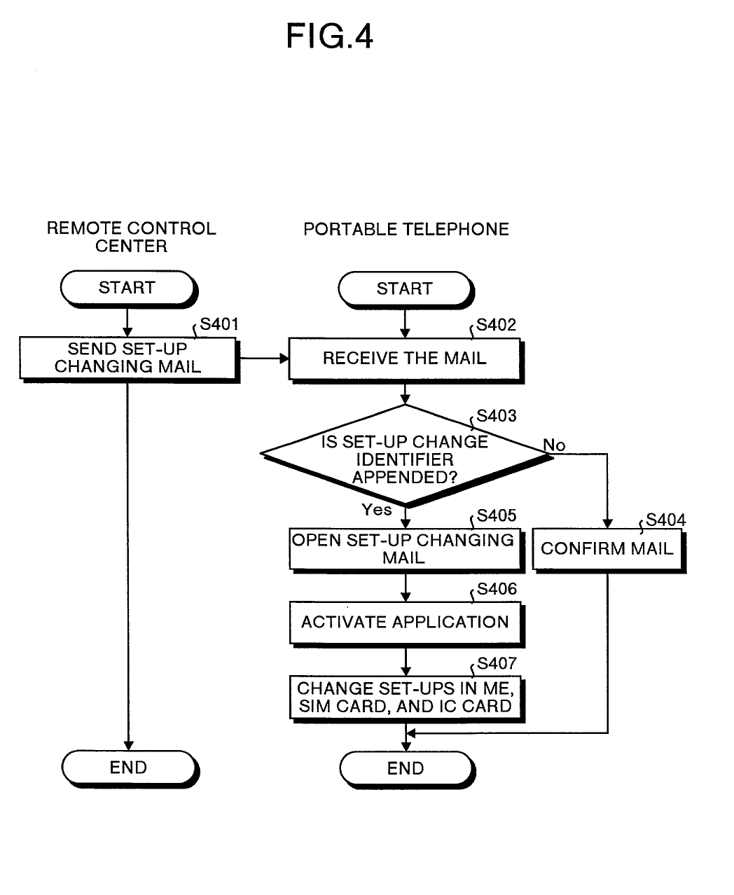

Next, the following description will describe an operation (setting changing job) in first embodiment of the present invention with reference to FIG. 4. FIG. 4 shows a flowchart detailing the operation in first embodiment of the present invention. The explanation will be given on the assumption that the remote control center 10 has completed the jobs of: accepting a request related to the set-up change, authenticating the subscriber's identification, and determining the setting changing application suitable to the request.

As shown in FIG. 4, the remote control center 10 sends the portable telephone 20 a mail containing the setting changing application that changes the setting in the ME 30, SIM card 40, and IC card 50 forming the portable telephone 20 (Step S401).

Then, the portable telephone 20 receives the mail containing the setting changing application from the remote control center 10 (Step S402), and judges whether the set-up change identifier is appended to the mail or not (Step S403).

Upon judging that the set-up change identifier is appended (Yes in Step S403), the portable telephone 20 automatically opens the mail containing the setting changing application in response to the set-up change identifier (Step S405).

Then, the portable telephone 20 activates the setting changing application contained in the opened mail (Step S406) and collectively changes the setting in the ME 30, SIM card 40, and IC card 50 forming the portable telephone 20 (Step 407). Upon judging that the set-up change identifier is not appended (No in Step S403), the portable telephone 20 judges that it is a normal mail and displays the content thereof (Step S404).

As described above, according to first embodiment, the remote control center 10 accepts a request related to the set-up change in the portable telephone 20 from the user of the portable telephone 20, and sends the portable telephone 20 a setting changing mail that collectively changes the storage contents in the ME 30, SIM card 40, and IC card 50 in response to the accepted request, whereby the portable telephone 20 collectively updates the storage contents in the ME 30, SIM card 40, and IC card 50 based on the setting changing mail. Thus, the setting in the ME 30, SIM card 40, and IC card 50 can be changed collectively by sending a communication mail only once, thereby making it possible to change the setting in the portable telephone 20 efficiently.

Furthermore, the ME 30 runs the application contained in the setting changing mail, so that the storage contents in the ME 30, SIM card 40, and IC card 50 are updated. Hence, the setting can be changed efficiently in the portable telephone 20 that realizes complicated functions.

In addition, the control section 32 in the ME 30 updates the storage contents in the storage unit 31 in the ME 30 by running the application contained in the setting changing mail, while at the same time, the storage contents in the storage units 41 and 51 provided respectively in the SIM card 40 and IC card 50 are updated by means of a processor-to-processor communication between the control section 32 in the ME 30 and the control sections 42 and 52 respectively provided with the SIM card 40 and IC card 50. Consequently, the setting can be changed efficiently in the portable telephone 20 provided with a plurality kinds of storage media and thereby effecting various kinds of functions. In particular, the set-up change that disables the functions of the SIM card 40 and IC card 50 besides the ME 30 is effective in case of loss of the portable telephone 20.

Furthermore, the remote control center 10 sends a setting changing mail containing the application that collectively changes the ME 30, SIM card 40, and IC card 50 and appended with the set-up change identifier, and when the set-up change identifier is present in the mail, the portable telephone 20 activates the application contained in the mail, whereby the storage contents in the ME 30, SIM card 40, and IC card 50 are updated collectively. Thus, the setting can be changed efficiently without requiring the user to apply special manipulations on the portable telephone 20 for the set-up change. In particular, the set-up change that disables the function by means of remote control is effective in case of loss of the portable telephone 20.

In addition, upon acceptance of a request related to the set-up change in the portable telephone 20 from the user of the portable telephone 20, the remote control center 10 generates a setting changing mail that contains a suitable application to the accepted request. Thus, the setting in the portable telephone 20 can be changed efficiently as the user desires.

Furthermore, upon acceptance of a request related to the set-up change in the portable telephone 20 from the user of the portable telephone 20, the remote control center 10 authenticates the user's identification as the authorized subscriber, and upon authentication as the authorized subscriber, the remote control center 10 generates a setting changing mail that contains an application suitable to the accepted request. Consequently, it is possible to prevent a change of the setting in the portable telephone 20 as intended by a third party other than the subscriber.

The first embodiment described a case where the portable telephone provided with the SIM card 40 and IC card 50 is remotely controlled. However, the present invention is not limited to the above case. That is, the present invention can be adapted to a case where an external device remotely controls any kind of portable terminal (for example, PDA, etc.) composed of a device main body provided with a built-in memory and an attachable/detachable storage medium.

Incidentally, first embodiment above described a case where the portable telephone, in which the SIM card and IC card are inserted in the ME, receives the setting changing application and runs the setting changing job. The present invention is not limited to the above case. That is, even when the SIM card or IC card having changed their set-ups is pulled out, and other SIM card or IC card is newly inserted, the portable telephone can run the same setting changing job for the latter SIM card or IC card.

The second embodiment of the present invention will describe a setting changing job in the portable telephone, in which the SIM card having its set-ups changed is pulled out, and a new SIM card is inserted. In the second embodiment, the system arrangement of the portable telephone remote control system is the same as that shown in FIG. 1, the arrangement of the remote control center 10 is the same as that shown in FIG. 2, and the arrangement of the portable telephone 20 is the same as that shown in FIG. 3. Thus, the explanation of the foregoing is omitted, and the following description will describe only an operation (setting changing job on the newly inserted SIM card) in the second embodiment of the present invention.

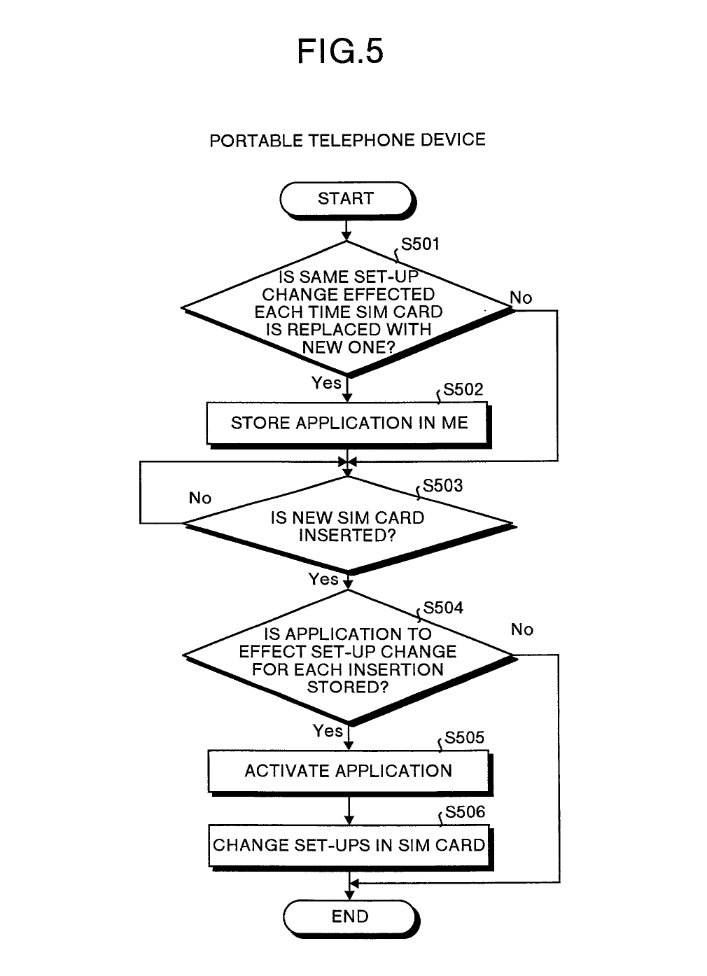

FIG. 5 shows a flowchart detailing the operation in second embodiment of the present invention. The explanation will be given on the assumption that the setting changing job described in first embodiment has been completed.

That is, the explanation will be given on the assumption that, upon acceptance of an additional request related to the set-up change in the portable telephone 20 specifying “to effect the same set-up change for the SIM card 40 each time it is replaced with a new one”, the control unit 14 in the remote control center 10 has sent a setting changing application appended with an identifier specifying “to effect the same set-up change each time the SIM card is replaced with a new one” to the portable telephone 20, which accordingly has run the setting changing job described in first embodiment by using the received setting changing application.

As shown in FIG. 5, upon completion of the setting changing job by using the setting changing application, if the portable telephone 20 judges that the setting changing application is the one specifying “to effect the same set-up change each time the SIM card is replaced with a new one” from the identifier (Yes in Step S501), the portable telephone 20 stores the setting changing application in the storage unit 31 in the ME 30 (Step S502).

When the SIM card 40 to which the setting changing job has been applied is pulled out and a new SIM card is inserted (Yes in Step S503) the portable telephone 20 judges whether the setting changing application specifying “to effect the same set-up change each time the SIM card is replaced with a new one” is stored in the storage unit 31 in the ME 30 (Step S504).

Upon judging that the setting changing application specifying “to effect the same set-up change each time the SIM card is replaced with a new one” is stored (Yes in Step S504) the portable telephone 20 activates the application (Step S505) and changes the setting in the newly inserted SIM card in the same manner as the replaced SIM card 40 (Step S506).

As explained above, according to the second embodiment, when a setting changing mail is stored in the storage unit 31 in the ME 30 and the SIM card 40 is replaced with a new SIM card, the portable telephone 20 updates the storage contents in said latter SIM card by running the application contained in the stored setting changing mail. Consequently, when the user wishes to change the set-ups in the newly inserted SIM card in the same manner as the replaced one, the portable telephone 20 does not have to receive the setting changing mail again from the remote control center 10, thereby making it possible to change the setting in the portable telephone 20 efficiently. In particular, the set-up change that disables the functions of the portable telephone is effective when a third party tries to use in bad faith someone else's lost portable telephone by inserting a new SIM card.

The second embodiment explained a case where the SIM card 40 is replaced with another SIM card. However, the present invention is not limited to this case. That is, the present invention can be adapted to a case where the IC card 50 is replaced with another IC card.

The second Embodiment described a case where, if the SIM card or IC card having its set-ups changed is pulled out and another SIM card or IC card is newly inserted into the portable telephone, the setting changing job is carried out for the latter SIM card or IC card in the same manner as before. However, the present invention is not limited to the case. That is, when the SIM card or IC card having its set-ups changed is pulled out and reinserted into another portable telephone provided with the ME having its set-ups unchanged, the same setting changing job can be run for the ME.

The third embodiment of the present invention will explain a setting changing job in a portable telephone 21, into which the SIM card pulled out from the portable telephone 20 is reinserted. The system arrangement of the portable telephone remote control system is the same as that shown in FIG. 1, the arrangement of the remote control center 10 is the same as that shown in FIG. 2, and the arrangement of each of the portable telephones 20 and 21 is the same as that shown in FIG. 3. Thus, the explanation of the foregoing is omitted, and the following description will describe only an operation (setting changing job for the ME after reinsertion) in the third embodiment of the present invention.

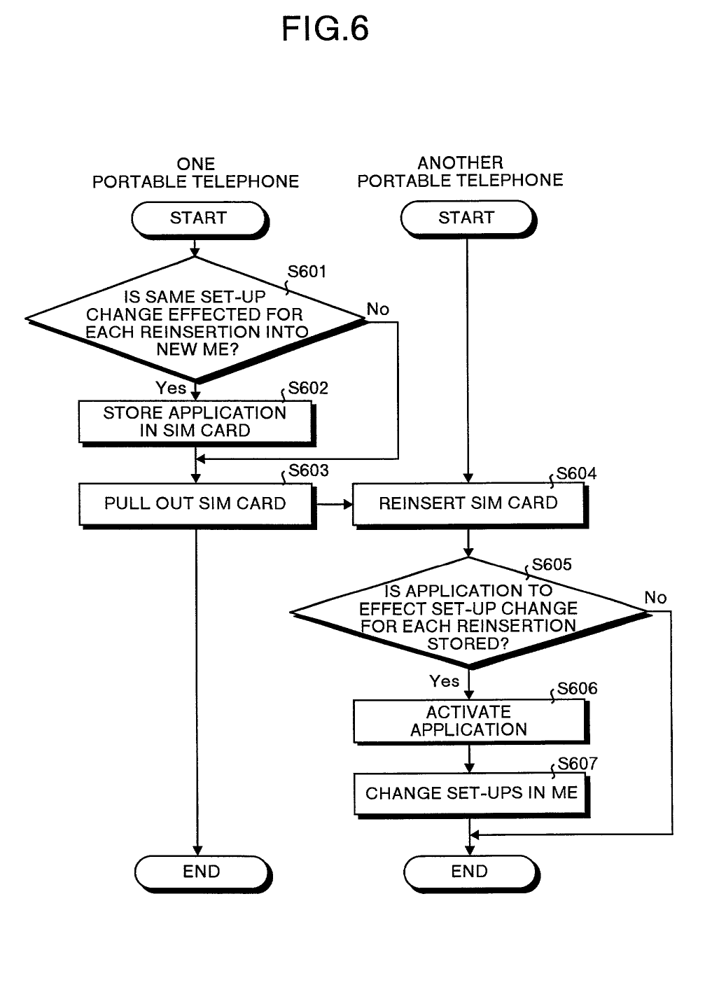

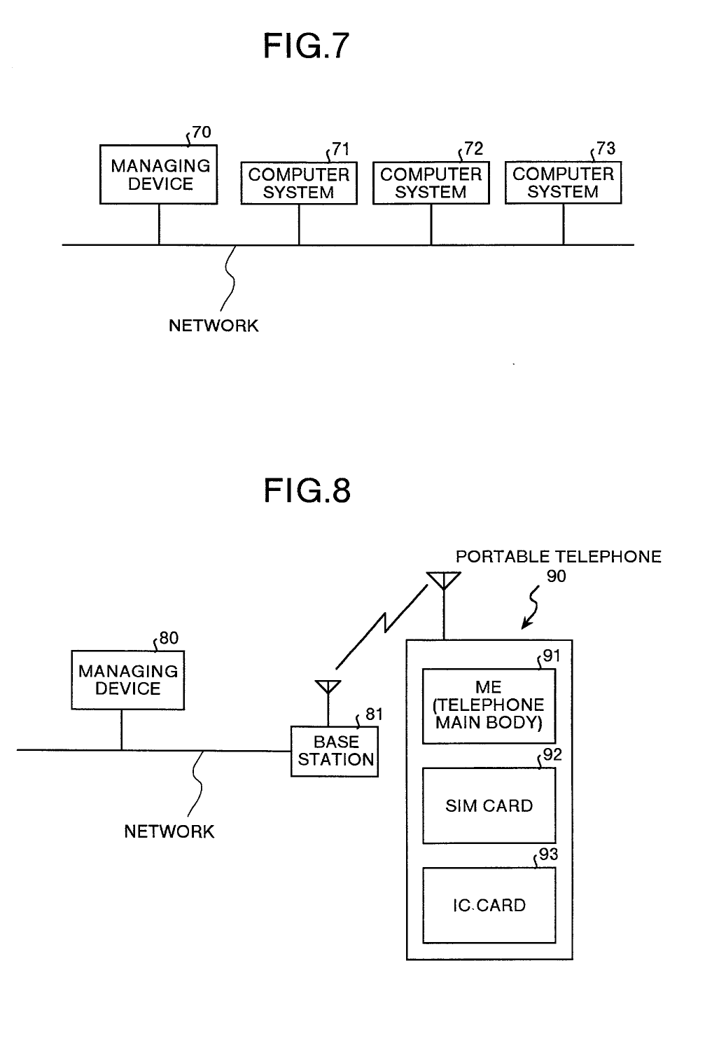

FIG. 6 shows a flowchart detailing the operation in the third embodiment of the present invention. The explanation will be given on the assumption that the setting changing job explained in first embodiment has been completed.

More specifically, the explanation will be given on the assumption that, upon acceptance of an additional request related to the set-up change in the portable telephone 20 specifying “to effect the same set-up change to the ME in another portable telephone each time the SIM card 40 is reinserted into a new portable telephone”, the control unit 14 in the remote control center 10 has sent the setting changing application appended with the identifier specifying “to effect the same set-up change to the ME each time the SIM card is reinserted into a new ME” to the portable telephone 20, which accordingly has run the setting changing job described in first embodiment by using the received setting changing application.

As shown in FIG. 6, upon completion of the setting changing job by using the setting changing application, if the portable telephone 20 judges that the setting changing application is the one specifying “to effect the same set-up change to the ME each time the SIM card is reinserted into a new ME” from the identifier (Yes in Step S601), the portable telephone 20 stores the setting changing application in the storage unit 41 in the SIM card 40 (Step S602).

The SIM card 40 having its set-ups changed is pulled out from the portable telephone 20 (Step S603), and the pulled out SIM card 40 is reinserted into another portable telephone 21 (Step S604).

The portable telephone 21 into which the SIM card 40 is reinserted judges whether the setting changing application specifying “to effect the same set-up change to the ME each time the SIM card is reinserted into a new ME” is stored in the storage unit 41 in the SIM card 40 (Step S605).

Upon judging that the setting changing application specifying “to effect the same set-up change to the ME each time the SIM card is reinserted into a new ME” is stored (Yes in Step S605), the portable telephone 21 activates the application (Step S606) and changes the setting in the ME in the portable telephone 21 to those in the ME 30 in the portable telephone 20 (Step S607).

As explained above, according to the third embodiment, when the setting changing mail is stored in the SIM card 40 and the SIM card 40 is reinserted into another portable telephone 21, the portable telephone 20 runs the application contained in the stored setting changing mail, whereby the storage contents in the ME in the portable telephone 21 are updated. Consequently, in case that the SIM card 40 having its set-ups changed is reinserted into another portable telephone 21 and the set-ups in the new ME are to be changed in the same manner, the portable telephone 21 does not have to receive the setting changing mail again from the remote control center 10, thereby making it possible to change the setting in the portable telephone 21 efficiently. In particular, the set-up change that disables the functions of the portable telephone is effective when a third party tries to pull out in bad faith the SIM card from someone else's lost portable telephone and reinsert the same into another portable telephone.

The third embodiment explained a case where the SIM card 40 is reinserted into another portable telephone 21. However, the present invention is not limited to this case. That is, the present invention can be adapted to a case where the IC card 50 is reinserted into another portable telephone 21.

Three embodiments of the present invention have been described above with reference to the accompanying drawings. However, concrete examples of the arrangement are not limited to the explained three embodiments. That is, design modifications and the like in various manners without deviating from the subject of the present invention are included in the present invention.

The portable telephone remote control method explained in the first to third embodiments can be achieved by running a prepared program by a computer, such as a personal computer and a workstation. Such a program is recorded in a computer-readable recording medium, such as a hard disk, a floppy disk, a CD-ROM, an MO, and a DVD, and run when read out from the recording medium by the computer. Also, such a program can be distributed by way of a recoding medium via a network, such as the Internet.

As explained above, according to the present invention, in a portable terminal remote control method for allowing an external device to remotely control a portable terminal composed of a main body provided with a built-in memory and an attachable/detachable storage medium, a request related to a change of setting in the portable terminal from a user of the portable terminal is accepted, and a setting changing mail that collectively changes storage contents in the built-in memory and storage medium is sent to the portable terminal owned by said user in response to the request accepted. Consequently, the set-ups in the main body and storage medium can be changed collectively by sending a communication mail only once, thereby achieving an effect that the setting in the portable terminal can be changed efficiently.

Furthermore, according the present invention, in a portable terminal remote control method for a portable terminal composed of a main body provided with a built-in memory that is remotely controlled by an external device and an attachable/detachable storage medium, a setting changing mail that is sent from the external device and collectively changes storage contents in the built-in memory and storage medium is received, and the storage contents in the built-in memory and storage medium are collectively updated based on the mail received. Consequently, the set-ups in the main body and storage medium can be changed collectively by sending a communication mail only once, thereby achieving an effect that the setting in the portable terminal can be changed efficiently.

Furthermore, according to the present invention, the storage contents in the built-in memory are updated by running an application contained in the setting changing mail by a processor in the main body, and the storage contents in the IC card or subscriber identity module card are updated by means of a processor-to-processor communication between the processor in the main body and the processor in the IC card or subscriber identity module card. Consequently, there can be achieved an effect that the setting can be changed efficiently even in a portable terminal that is provided with a plurality of storage media and thereby realizes various kinds of functions.

Furthermore, according to the present invention, the setting changing mail is stored in the internal memory, and when the storage medium is replaced with said another storage medium, storage contents in another storage medium are updated by running the application contained in the setting changing mail stored in the internal memory. Consequently, when effecting the same change of setting to a newly inserted recording medium, it does not have to receive the setting changing mail from the external device again, thereby achieving an effect that the setting in the portable terminal can be changed effectively.

Furthermore, according to the present invention, the setting changing mail is stored in the storage medium, and when the storage medium is reinserted into another main body, storage contents in an internal memory in said another main body are updated by running the application contained in the setting changing mail stored in the storage medium. Consequently, when effecting the same change of setting to a new main body into which the storage medium having its set-ups changed, it does not have to receive the setting changing mail again from the external device, thereby achieving an effect that the setting in the portable terminal can be changed efficiently.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A portable terminal remote control method of remotely controlling a portable terminal from an external device, which portable terminal having a) a main body provided with a built-in memory, and b) an attachable/detachable storage medium, the method comprising:
a step of accepting a request by said external device related to a change of setting in said portable terminal from a user of said portable terminal; and
a setting changing mail sending step of sending a setting changing mail, by said external device to said portable terminal, that collectively changes the contents of said built-in memory and said storage medium of said portable terminal, in response to the received request.

2. The portable terminal remote control method according to claim 1,
wherein in the setting changing mail sending step, a setting changing mail including a computer program that changes the contents of said built-in memory and said storage medium and a change of setting identifier is sent.

3. The portable terminal remote control method according to claim 1,
wherein the setting changing mail sending step includes a setting changing mail generating step of, upon acceptance of the request related to the change of setting in said portable terminal, generating the setting changing mail containing a computer program suitable to the received request.

4. The portable terminal remote control method according to claim 3 further comprising:
an authenticating step of, upon acceptance of the request related to the change of setting in said portable terminal from the user of said portable terminal, checking whether the user is an authorized user or not, and generating the setting changing mail only when the user is an authorized user.

5. A portable terminal remote control method of remotely controlling a portable terminal from an external device, which portable terminal having a) a main body provided with a built-in memory, and b) an attachable/detachable storage medium, the method comprising:
a step of receiving a setting changing mail, sent from said external device in said portable terminal, by which contents of said built-in memory and said storage medium can be collectively changed; and
a first updating step of collectively updating the contents of said built-in memory and said storage medium based on the content of the received setting changing mail.

6. The portable terminal remote control method according to claim 5, wherein in the first updating step, said main body updates the contents of said built-in memory and said storage medium by executing a computer program contained in said setting changing mail.

7. The portable terminal remote control method according to claim 5,
wherein said storage medium is composed of an IC card or a subscriber identity module card issued by a communication provider, each provided with a processor and a memory, so that in the first updating step, said main body having a processor that updates the contents of said built-in memory by executing a computer program contained in said setting changing mail, and said IC card or subscriber identity module card are updated by means of a processor-to-processor communication between the processor in said main body and the processor in said IC card or subscriber identity module card.

8. The portable terminal remote control method according to claim 5 further comprising:
a first storing step of storing the received setting changing mail in said internal memory; and
a second updating step of, when said storage medium is replaced with another storage medium, updating the contents of said another storage medium by running the computer program contained in the setting changing mail stored in said internal memory.

9. The portable terminal remote control method according to claim 5 further comprising:
a first storing step of storing the received setting changing mail in said storage medium; and
a third updating step of, when said storage medium is inserted into a main body of an another portable terminal, updating the contents in an internal memory of said main body of an another portable terminal by running the computer program contained in the setting changing mail stored in said storage medium.

10. The portable terminal remote control method according to claim 5,
wherein in the step of receiving a setting changing mail, a setting changing mail including a computer program that changes the contents of said built-in memory and said storage medium and a change of setting identifier is received; and
wherein in the first updating step, if the change of setting identifier is present in a setting changing mail, the contents of said built-in memory and said storage medium are updated collective by executing the computer program contained in the setting changing mail.

11. A portable terminal remote control system having at least one external device and at least one portable terminal and capable of remotely controlling said portable terminal from said external device, which portable terminal having a) a main body provided with a built-in memory, and b) an attachable/detachable storage medium,
wherein said external device having,
an accepting unit which accepts a request related to a change of setting in said portable terminal from a user of said portable terminal; and
a setting changing mail sending unit which sends a setting changing mail, to said portable terminal, that collectively changes the contents of said built-in memory and said storage medium of said portable terminal, in response to the received request.

12. A computer-readable recording medium, in which a portable terminal remote control program is recorded for allowing an external device to remotely control a portable terminal composed of a main body provided with a built-in memory and an attachable/detachable storage medium, characterized by recording a portable terminal remote control program to have a computer carry out:
a step of accepting a request by said external device related to a change of setting in said portable terminal from a user of said portable terminal; and
a setting changing mail sending step of sending a setting changing mail, by said external device to said portable terminal, that collectively changes the contents of said built-in memory and said storage medium of said portable terminal, in response to the received request.

13. A portable terminal remote control system having at least one external device and at least one portable terminal and capable of remotely controlling said portable terminal from said external device, which portable terminal having a) a main body provided with a built-in memory, and b) an attachable/detachable storage medium,
wherein said portable device having,
a setting changing mail receiving unit which receives a setting changing mail sent from said external device, by which contents of said built-in memory and said storage medium can be collectively changed; and
an updating unit which collectively updates the contents of said built-in memory and said storage medium based on the content of the received setting changing mail.
